(19) United States
(12) Patent Application Publication
(10) Pub. No.: US 2026/0360702 A1
(43) Pub. Date: Nov. 12, 2026

(54) POSITIVE ELECTRODE ACTIVE SUBSTANCE FOR LITHIUM SECONDARY BATTERY, METHOD FOR PRODUCING THE SAME AND LITHIUM SECONDARY BATTERY

(71) Applicant: NIPPON CHEMICAL INDUSTRIAL CO., LTD., Tokyo (JP)

(72) Inventors: Yuta Shiraishi, Tokyo (JP); Masahiro Kikuchi, Tokyo (JP); Minoru Fukuchi, Tokyo (JP)

(73) Assignee: NIPPON CHEMICAL INDUSTRIAL CO., LTD., Tokyo (JP)

(21) Appl. No.: 19/135,489

(22) PCT Filed: Nov. 30, 2023
(86) PCT No.: PCT/JP2023/042926

§ 371 Date: Jun. 4, 2025

(30) Foreign Application Priority Data
Dec. 7, 2022 (JP) 2022-195535
Sep. 26, 2023 (JP) 2023-162917

(51) Int. Cl. H01M 4/36; C01G 51/42; H01M 4/525; H01M 4/58; H01M 4/62; H01M 10/0525

(52) U.S. Cl. CPC H01M 4/364; C01G 51/42; H01M 4/525; H01M 4/582; H01M 4/628; H01M 10/0525; C01P 2004/51; C01P 2004/61

(57) ABSTRACT

There is provided a positive electrode active substance for a lithium secondary battery which substance is excellent in cycle characteristics at high voltages and can be lowered in the impedance, wherein the positive electrode active substance comprises a mixture of aluminum-containing lithium cobalt composite oxide particles and inorganic fluoride particles; the aluminum-containing lithium cobalt composite oxide particles contain aluminum solid-soluted and present at least in the interior of the aluminum-containing lithium cobalt composite oxide particles; and the inorganic fluoride particles are MgF₂ and a compound containing Al and F.

### TECHNICAL FIELD

The present invention relates to a positive electrode active substance for a lithium secondary battery, a method for producing the same, and a lithium secondary battery using the positive electrode active substance.

### BACKGROUND ART

In recent years, along with rapid progress of making household appliances portable and cordless, lithium ion secondary batteries have been put in practical use as power sources of small electronic devices such as laptop personal computers, mobile phones and video cameras. With regard to the lithium ion secondary batteries, since Mizushima et al. reported in 1980 that lithium cobaltate is useful as a positive electrode active substance of a lithium ion secondary battery, research and development of lithium-based composite oxides has been actively progressed and many proposals have been made.

However, along with upsizing and performance enhancement of electronic devises, further improvements in various characteristics of batteries are needed.

The present applicant has previously variously proposed positive electrode active substances for a lithium secondary battery which substances can make the lithium secondary battery excellent in cycle characteristics even at high voltages. For example, Patent Literature 1 proposes such a positive electrode active substance for a lithium secondary battery that the use of a mixture of lithium cobalt composite oxide particles and inorganic fluoride particles as the positive electrode active substance for a lithium secondary battery can make the lithium secondary battery excellent in the cycle characteristics, high in the energy capacity retention rate and little in lowering of the average operation voltage. Further, for example, Patent Literature 2 proposes such a positive electrode active substance for a lithium secondary battery that the use of a mixture of titanium-containing lithium cobalt composite oxide particles and inorganic fluoride particles as the positive electrode active substance for a lithium secondary battery can make the lithium secondary battery excellent in the cycle characteristics, little in lowering of the average operation voltage, excellent in retention of a high average operation voltage and high in the energy density retention rate.

### CITATION LIST

### Patent Literature

Patent Literature 1: Japanese Patent Laid-Open No. 2020-064712
Patent Literature 2: Japanese Patent Laid-Open No. 2020-064711

### SUMMARY OF INVENTION

### Technical Problem

However, the above conventional technologies have not yet attained batteries concurrently having various characteristics of the performance thereof in high levels, and do not meet requirements for improvements in characteristics of batteries in recent years.

In particular, batteries to be used for electric bicycles, electric vehicles, robots, drones, backup power sources and the like are supposed to be used at high voltages and at high outputs.

Hence, the improvement in the cycle characteristics at a temperature of about 25 °C and high voltages, and a low impedance have been demanded. Further, in addition to the above battery performance, the improvement in the cycle characteristics at high temperatures of about 45 to 60 °C and high voltages have been demanded.

Accordingly, the present invention has an object to provide: a positive electrode active substance for a lithium secondary battery which substance, when being used as a positive electrode active substance for a lithium secondary battery, is excellent in the cycle characteristics at high voltages and can be lowered in the impedance; an industrially advantageous method for producing the same; and the lithium secondary battery which is excellent in the cycle characteristics at high voltages and can be lowered in the impedance.

Further, an object of the present invention is to provide: a positive electrode active substance for a lithium secondary battery which substance is excellent, in addition to the above battery performance, in the cycle characteristics at high temperatures and at high voltages; an industrially advantageous method for producing the same; and the lithium secondary battery which is excellent in, in addition to the above battery performance, the cycle characteristics at high temperatures and at high voltages.

### Solution to Problem

As a result of exhaustive studies in consideration of the above real situation, the present inventor has found that the use, as a positive electrode active substance for a lithium secondary battery, of a mixture of aluminum-containing lithium cobalt composite oxide particles containing aluminum solid-soluted in the interior of lithium cobalt composite oxide particles, and inorganic fluoride particles being MgF₂ and a compound containing Al and F makes a lithium secondary battery excellent in cycle characteristics at high voltages and low in the impedance and the like, and this finding has led to the completion of the present invention.

That is, the present invention (1) provides a positive electrode active substance for a lithium secondary battery, the positive electrode active substance comprising a mixture of aluminum-containing lithium cobalt composite oxide particles and inorganic fluoride particles,
wherein the aluminum-containing lithium cobalt composite oxide particles contain aluminum solid-soluted and present at least in the interior of the aluminum-containing lithium cobalt composite oxide particles; and the inorganic fluoride particles are MgF₂ and a compound containing Al and F.

Then, the present invention (2) provides the positive electrode active substance for a lithium secondary battery according to (1), wherein the compound containing Al and F is AlF₃ and/or LiAlF₄.

Then, the present invention (3) provides the positive electrode active substance for a lithium secondary battery according to (1) or (2), wherein the content of Al in the aluminum-containing lithium cobalt composite oxide particles is, in % by mol ((Al/Co)×100) in terms of atoms of Al with respect to Co in the aluminum-containing lithium cobalt composite oxide particles, 0.05 to 5.0% by mol.

Then, the present invention (4) provides the positive electrode active substance for a lithium secondary battery according to any one of (1) to (3), wherein the content of F in the aluminum-containing lithium cobalt composite oxide particles is, in % by mol ((F/Co)×100) in terms of atoms of F with respect to Co in the aluminum-containing lithium cobalt composite oxide particles, 0.05 to 5.0% by mol.

Then, the present invention (5) provides the positive electrode active substance for a lithium secondary battery according to any one of (1) to (4), wherein the mixing proportion of the MgF₂ and the compound containing Al and F is, in a ratio (a molar number in terms of atoms of F of MgF₂/a molar number in terms of atoms of F of the compound containing Al and F) of a molar number in terms of atoms of F of MgF₂ to a molar number in terms of atoms of F of the compound containing Al and F, 0.033 to 33.

Then, the present invention (6) provides the positive electrode active substance for a lithium secondary battery according to any one of (1) to (5), wherein the positive electrode active substance has a lattice constant of the c axis of 14.055 to 14.070 Å.

Then, the present invention (7) provides the positive electrode active substance for a lithium secondary battery according to any one of (1) to (6), wherein the aluminum-containing lithium cobalt composite oxide particles contain one or two or more M elements selected from the group consisting of Ca, Mg, Sr, Zr, Nb, B and W.

Then, the present invention (8) provides a positive electrode active substance for a lithium secondary battery, the positive electrode active substance being a fired material of a mixture of aluminum-containing lithium cobalt composite oxide particles and inorganic fluoride particles, wherein the aluminum-containing lithium cobalt composite oxide particles contain aluminum solid-soluted and present at least in the interior of the aluminum-containing lithium cobalt composite oxide particles; and the inorganic fluoride particles are MgF₂ and AlF.

Then, the present invention (9) provides the positive electrode active substance for a lithium secondary battery according to (8), wherein the aluminum-containing lithium cobalt composite oxide particles are a fired material of a mixture of a lithium compound, a cobalt compound and an aluminum compound.

Then, the present invention (10) provides the positive electrode active substance for a lithium secondary battery according to (8) or (9), wherein the content of Al in the aluminum-containing lithium cobalt composite oxide particles is, in % by mol ((Al/Co)×100) in terms of atoms of Al with respect to Co in the aluminum-containing lithium cobalt composite oxide particles, 0.05 to 5.0% by mol.

Then, the present invention (11) provides the positive electrode active substance for a lithium secondary battery according to any one of (8) to (10), wherein the amount of the inorganic fluoride particles mixed in the mixture of aluminum-containing lithium cobalt composite oxide particles and inorganic fluoride particles is, in % by mol (F/Co×100) in terms of atoms of F with respect to Co in the aluminum-containing lithium cobalt composite oxide particles, 0.05 to 5.0% by mol.

Then, the present invention (12) provides the positive electrode active substance for a lithium secondary battery according to any one of (8) to (11), wherein the mixing proportion of the MgF₂ in the mixture of aluminum-containing lithium cobalt composite oxide particles and inorganic fluoride particles is, in a molar ratio (MgF₂/AlF₃) with respect to the AlF₃, 0.05 to 50.

Then, the present invention (13) provides the positive electrode active substance for a lithium secondary battery according to any one of (8) to (12), wherein the positive electrode active substance has a lattice constant of the c axis of 14.055 to 14.070 Å.

Then, the present invention (14) provides the positive electrode active substance for a lithium secondary battery according to any one of (8) to (13), wherein the aluminum-containing lithium cobalt composite oxide particles contain one or two or more M elements selected from the group consisting of Ca, Mg, Sr, Zr, Nb, B and W.

Then, the present invention (15) provides a method for producing a positive electrode active substance for a lithium secondary battery, the method comprising:
a first mixing step of mixing a lithium compound, a cobalt compound and an aluminum compound as raw materials to obtain a first mixture;
a first firing step of firing the first mixture to obtain, as a first fired material, aluminum-containing lithium cobalt composite oxide particles containing aluminum solid-soluted and present at least in the interior of the particles;
a second mixing step of mixing the first fired material obtained in the first firing step with inorganic fluoride particles to obtain a second mixture; and
a second firing step of firing the second mixture to obtain, as a second fired material, a positive electrode active substance for a lithium secondary battery,
wherein the inorganic fluoride particles are MgF₂ and AlF₃.

Then, the present invention (16) provides the method for producing a positive electrode active substance for a lithium secondary battery according to (15), wherein in the first mixing step, the aluminum compound is mixed so that the % by mol ((Al/Co)×100) in terms of atoms of Al with respect to Co in the first mixture becomes 0.05 to 5.0% by mol.

Then, the present invention (17) provides the method for producing a positive electrode active substance for a lithium secondary battery according to (15) or (16), wherein the first fired material contains one or two or more M elements selected from the group consisting of Ca, Mg, Sr, Zr, Nb, B and W.

Then, the present invention (18) provides the method for producing a positive electrode active substance for a lithium secondary battery according to (15) or (17), wherein in the first firing step, the firing temperature is 800 to 1,150 °C.

Then, the present invention (19) provides the method for producing a positive electrode active substance for a lithium secondary battery according to (15) or (18), wherein in the second mixing step, the inorganic fluoride particles are mixed so that the % by mol ((F/Co)×100) in terms of atoms of F with respect to Co in the second mixture becomes 0.05 to 2.0% by mol.

Then, the present invention (20) provides the method for producing a positive electrode active substance for a lithium secondary battery according to (15) or (19), wherein the positive electrode active substance for a lithium secondary battery being the second fired material has a lattice constant of the c axis of 14.055 to 14.070 Å.

Then, the present invention (21) provides a lithium secondary battery, wherein the battery comprises, as a positive electrode active substance, a positive electrode active substance for a lithium secondary battery according to any one of (1) to (14).

### Advantageous Effects of Invention

According to the present invention, there can be provided: a positive electrode active substance for a lithium secondary battery which substance, when being used as a positive electrode active substance for a lithium secondary battery, is excellent in the cycle characteristics at high voltages and can be lowered in the impedance; an industrially advantageous method for producing the same; and the lithium secondary battery which is excellent in the cycle characteristics at high voltages and can be lowered in the impedance.

Further, according to the present invention, there can be provided a positive electrode active substance for a lithium secondary battery which substance is excellent, in addition to the above battery performance, in the cycle characteristics at high temperatures and at high voltages; an industrially advantageous method for producing the same; and the lithium secondary battery which is excellent in, in addition to the above battery performance, the cycle characteristics at high temperatures and at high voltages.

### BRIEF DESCRIPTION OF DRAWING

FIG. 1 is an X-ray diffraction pattern of an aluminum-containing lithium cobalt composite oxide obtained in the first firing step of Example 1.

### DESCRIPTION OF EMBODIMENTS

Hereinafter, the present invention will be described based on preferred embodiments.

A positive electrode active substance for a lithium secondary battery of a first embodiment of the present invention (hereinafter, described also as a positive electrode active substance for a lithium secondary battery (1), of the present invention) comprises a mixture of aluminum-containing lithium cobalt composite oxide particles (1) and inorganic fluoride particles,
wherein the aluminum-containing lithium cobalt composite oxide particles (1) contain aluminum solid-soluted and present at least in the interior of the aluminum-containing lithium cobalt composite particles; and the inorganic fluoride particles are MgF₂ and a compound containing Al and F.

Here, aluminum-containing lithium cobalt composite oxide particles relevant to the positive electrode active substance for a lithium secondary battery (1) of the present invention are described also as the aluminum-containing lithium cobalt composite oxide particles (1).

The positive electrode active substance for a lithium secondary battery (1) of the present invention is composed basically of a mixture of the aluminum-containing lithium cobalt composite oxide particles (1) and the inorganic fluoride particles.

An aluminum-containing lithium cobalt composite oxide to form the aluminum-containing lithium cobalt composite oxide particles (1) relevant to the positive electrode active substance for a lithium secondary battery (1) of the present invention is a composite oxide containing, at least, lithium, cobalt and aluminum, and is the composite oxide which is a lithium cobalt composite oxide containing aluminum added as an additional element. In the aluminum-containing lithium cobalt composite oxide particles (1) relevant to the positive electrode active substance for a lithium secondary battery (1) of the present invention, Al is solid-soluted and present at least in the interior of the aluminum-containing lithium cobalt composite oxide particles. Then, in the aluminum-containing lithium cobalt composite oxide particles (1) relevant to the positive electrode active substance for a lithium secondary battery (1) of the present invention, since due to that Al is solid-soluted and present at least in the interior of the aluminum-containing lithium cobalt composite oxide particles (1), the crystal structure of the lithium cobalt composite oxide particles themselves is stabilized also at high voltages, under suppression of reduction of the charge and discharge capacities, the cycle characteristics at high voltages are improved and more preferably, the cycle characteristics at high voltages and at high temperatures can be improved.

The fact that in the aluminum-containing lithium cobalt composite oxide particles (1) relevant to the positive electrode active substance for a lithium secondary battery (1) of the present invention, Al is solid-soluted and present in the interior of the aluminum-containing lithium cobalt composite oxide particles (1) means that the aluminum-containing lithium cobalt composite oxide particles (1) are single-phase aluminum-containing lithium cobalt composite oxide particles in which when the aluminum-containing lithium cobalt composite oxide particles (1) are X-ray diffractometrically analyzed using a CuKα line as a line source, substantially no diffraction peaks caused by an aluminum compound being a raw material and/or Al₂O₃ are detected.

Here, the state that substantially no diffraction peaks caused by an aluminum compound being a raw material and Al₂O₃ are detected refers to that diffraction peaks caused by the aluminum compound and Al₂O₃ are below the detection limit of the analyzer.

Then, as described later, the fact that Al is solid-soluted and present in the interior of the aluminum-containing lithium cobalt composite oxide particles (1) can be presumed also from the fact that the lithium cobalt composite oxide (1) containing Al solid-soluted in the interior of the particles has a larger lattice constant of the c axis than pure lithium cobalt composite oxide particles containing no Al solid-soluted in the interior of the particles.

In the aluminum-containing lithium cobalt composite oxide (1) relevant to the positive electrode active substance for a lithium secondary battery (1) of the present invention, Al is present only in the interior of the composite oxide particles in some cases, or is present in the interior and on the surface of the composite oxide particles in some cases; in the present invention, Al may be present in the interior of the composite oxide particles, or may be present on the surface of the composite oxide particles. Then, in the positive electrode active substance for a lithium secondary battery (1) of the present invention, it is preferable that Al is solid-soluted and present at least in the interior of the composite oxide particles, in terms that the structure of the composite oxide is stabilized. Then, the state that Al is solid-soluted and present at least in the interior of the composite oxide particles indicates the case where Al is present only in the interior of the particles and the case where Al is present both in the particle interior and on the particle surface.

In the aluminum-containing lithium cobalt composite oxide particles (1) relevant to the positive electrode active substance for a lithium secondary battery (1) of the present invention, the molar ratio (Li/Co) in terms of atoms of Li with respect to Co is preferably 0.90 to 1.20 and especially preferably 0.95 to 1.15. Due to that the molar ratio (Li/Co) in terms of atoms of Li with respect to Co in the aluminum-containing lithium cobalt composite oxide particles (1) is in the above range, the capacity per volume of the positive electrode active substance for a lithium secondary battery can be improved.

In the aluminum-containing lithium cobalt composite oxide particles (1) relevant to the positive electrode active substance for a lithium secondary battery (1) of the present invention, the % by mol ((Al/Co)×100) in terms of atoms of Al with respect to Co is preferably 0.05 o 5.0% by mol and especially preferably 0.5 to 2.05 by mol. Due to that the & by mol ((Al/Co)×100) in terms of atoms of Al with respect to Co in the aluminum-containing lithium cobalt composite oxide particles (1) is in the above range, under suppression of reduction of the charge and discharge capacities of the positive electrode active substance for a lithium secondary battery, the cycle characteristics at high voltages and the cycle characteristics at high voltages and at high temperatures, and the high-temperature storage characteristics can be improved.

The aluminum-containing lithium cobalt composite oxide particles (1) relevant to the positive electrode active substance for a lithium secondary battery (1) of the present invention contain Al as an essential additional element of the lithium cobalt composite oxide, but for the purpose of improving the performance or the physical properties, as required, can contain an M element(s). The M element is one or two or more metal elements selected from Ca, Mg, Sr, Zr, Nb, b and W.

In terms that the battery characteristics become much higher, it is preferable that the aluminum-containing lithium cobalt composite oxide particles (1) relevant to the positive electrode active substance for a lithium secondary battery (1) of the present invention contain, as the M element, at least one of Ca and Sr, and it is especially preferable to contain at least one of Ca and Sr, and one or more selected from Mg, Zr, Nb, B and W. Then, it is preferable that the aluminum-containing lithium cobalt composite oxide particles (1) relevant to the positive electrode active substance for a lithium secondary battery (1) of the present invention of the present invention contain, as the M element, at least one or two or more selected from Ca, Mg, Sr and Zr. Then, it is preferable that the aluminum-containing lithium cobalt composite oxide particles (1) relevant to the positive electrode active substance for a lithium secondary battery (1) of the present invention contain, as the M element, Mg, Sr and Zr.

In the case where the aluminum-containing lithium cobalt composite oxide particles (1) relevant to the positive electrode active substance for a lithium secondary battery (1) of the present invention contain the M element, the % by mol ((M/Co)×100) in terms of atoms of the M element with respect to Co atoms in the aluminum-containing lithium cobalt composite oxide particles (1) is preferably 0.01 to 2.0% by mol and especially preferably 0.05 to 1.0% by mol. In the case where the aluminum-containing lithium cobalt composite oxide particles (1) contain the M element, due to that the % by mol ((M/Co)×100) in terms of atoms of the M element with respect to Co in the aluminum-containing lithium cobalt composite oxide particles (1) is in the above range, the battery characteristics can be improved without impairing the charge and discharge capacities of the positive electrode active substance for a lithium secondary battery. Then, when the aluminum-containing lithium cobalt composite oxide contains two or more M elements, the molar number in terms of atom of the M elements, which becomes the basis of the calculation of the % by mol, refers to the total of molar numbers of the M elements.

The M element may be present in the particle interior of the aluminum-containing lithium cobalt composite oxide particles (1), or may be present on the particle surface thereof, or may be present both in the particle interior and on the particle surface thereof.

In the case where the M element is present on the particle surface of the aluminum-containing lithium cobalt composite oxide particles (1), the M element may also be present in a form of an oxide, a composite oxide, a sulfate salt, a phosphate salt or the like.

The average particle diameter of the aluminum-containing lithium cobalt composite oxide particles (1) relevant to the positive electrode active substance for a lithium secondary battery (1) of the present invention is, in the particle diameter (D50) at a cumulative volume of 50% in a particle size distribution determined by a laser diffraction scattering method, preferably 0.5 to 30 μm and especially preferably 3 to 25 μm. Then, the BET specific surface area of the aluminum-containing lithium cobalt composite oxide particles (1) is preferably 0.05 to 5.0 m²/g and especially preferably 0.15 to 1.0 m²/g. Due to that the average particle diameter or the BET specific surface area of the aluminum-containing lithium cobalt composite oxide particles (1) is in the above range, the preparation and the coatability of a positive electrode mixture become easy, and further, an electrode high in the packing property can be obtained.

Also one feature is that the inorganic fluoride particles relevant to the positive electrode active substance for a lithium secondary battery (1) of the present invention are in combination of MgF₂ with a compound containing Al and F. Hereinafter, the MgF₂ and the compound containing Al and F are referred to generically as “inorganic fluorides” or “inorganic fluoride particles” in some cases. The compound containing Al and F includes AlF₃ and/or LiAlF₄.

The content of the inorganic fluoride particles in the positive electrode active substance for a lithium secondary battery (1) of the present invention is, in by mol ((F/Co)×100) in terms of atoms of F with respect to Co in the aluminum-containing lithium cobalt composite oxide particles (1), preferably 0.05 to 5.0% by mol and especially preferably 0.1 to 2.0% by mol. Due to that the % by mol ((F/Co)×100) in terms of atoms of F with respect to Co in the aluminum-containing lithium cobalt composite oxide particles (1) is in the above range, under suppression of reduction of the charge and discharge capacities, such an effect is enhanced that the cycle characteristics at high voltages are improved, and the impedance of the positive electrode active substance for a lithium secondary battery can be lowered.

The mixing proportion of MgF₂ and the compound containing Al and F is, in the ratio (the molar number in terms of atoms of F of MgF₂/the molar number in terms of atoms of F of the compound containing Al and F) of the molar number in terms of atoms of F of MgF₂ with respect to the molar number in terms of atoms of F of the compound containing Al and F, 0.033 to 33, and preferably 0.1 to 20 and especially preferably 1 to 10. Due to that the ratio (the molar number in terms of atoms of F of MgF₂/the molar number in terms of atoms of F of the compound containing Al and F) of the molar number in terms of atoms of F of MgF₂ with respect to the molar number in terms of atoms of F of the compound containing Al and F is in the above range, the initial discharge capacity and the impedance are both simultaneously satisfied, which is preferable.

The inorganic fluoride particles may be present on the particle surface of the aluminum-containing lithium cobalt composite oxide particles (1), or may be present simply in a mixing state with the aluminum-containing lithium cobalt composite oxide particles (1), or may be in both the states. That is, the positive electrode active substance for a lithium secondary battery of the present invention may be composed of the aluminum-containing lithium cobalt composite oxide particles (1) and the inorganic fluoride particles present on the surface of the aluminum-containing lithium cobalt composite oxide particles (1), or may be composed of a simple mixture of the aluminum-containing lithium cobalt composite oxide particles (1) and the inorganic fluoride particles, or may be a mixture of both the forms. Then in the case where the inorganic fluoride particles are present on the particle surface of the aluminum-containing lithium cobalt composite oxide particles (1), it is preferable that the inorganic fluoride particles are present partially on the surface of the aluminum-containing lithium cobalt composite oxide particles (1), in terms that the intercalation and deintercalation of lithium through the surface of the aluminum-containing lithium cobalt composite oxide is not inhibited.

The average particle diameter of the inorganic fluoride particles is, in the particle diameter (D50) at a cumulative volume of 50% in a particle size distribution determined by a laser diffraction scattering method, preferably 0.01 to 30 μm and especially preferably 0.1 to 20 μm. Due to that the average particle diameter of the inorganic fluoride particles is in the above range, trouble becomes less likely to be caused in a kneading step in preparation of a positive electrode mixture and in a coating step of coating the obtained positive electrode mixture on a positive electrode current collector.

The average particle diameter of the positive electrode active substance for a lithium secondary battery (1) of the present invention is, in the particle diameter (D50) at a cumulative volume of 50% in a particle size distribution determined by a laser diffraction scattering method, preferably 0.5 to 30 μm and especially preferably 3 to 25 μm. Then, the BET specific surface area of the positive electrode active substance for a lithium secondary battery (1) of the present invention is preferably 0.05 to 5.0 m²/g and especially preferably 0.15 to 1.0 m²/g. Due to that the average particle diameter or the BET specific surface area of the positive electrode active substance for a lithium secondary battery (1) of the present invention is in the above range, trouble becomes less likely to be caused in a kneading step in preparation of a positive electrode mixture and in a coating step of coating the obtained positive electrode mixture on a positive electrode current collector.

The present inventors presume that Al solid-soluted and contained in LiCoO₂ has an influence on the crystal structure of pure LiCoO₂. That is, whereas the lattice constant of the c axis of the pure LiCoO₂ containing no Al solid-soluted in the particle interior is 14.050 to 14.055 Å, the positive electrode active substance for a lithium secondary battery (1) of the present invention has a higher lattice constant of the c axis than that of the pure LiCoO₂. The present inventors presume that this is due to the influence by Al solid-soluted and present in the lithium cobalt composite oxide.

The lattice constant of the c axis of the positive electrode active substance for a lithium secondary battery (1) of the present invention is preferably 14.055 to 14.070 Å and especially preferably 14.055 to 14.065 Å. Due to that the lattice constant of the c axis is in the above range, collapse of the crystal structure can be reduced and the cycle characteristics can be improved.

A method for producing a positive electrode active substance for a lithium secondary battery of the present invention has:
a first mixing step of mixing a lithium compound, a cobalt compound and an aluminum compound as raw materials to obtain a first mixture;
a first firing step of firing the first mixture to obtain, as a first fired material, aluminum-containing lithium cobalt composite oxide particles (2) containing aluminum solid-soluted and present at least in the interior of the particles;
a second mixing step of mixing the first fired material obtained in the first firing step with inorganic fluoride particles to obtain a second mixture; and
a second firing step of firing the second mixture to obtain, as a second fired material, the positive electrode active substance for a lithium secondary battery,
wherein the inorganic fluoride particles are MgF₂ and AlF₃.

Then, in the method for producing the positive electrode active substance for a lithium secondary battery of the present invention, aluminum-containing lithium cobalt composite oxide particles before being mixed with the inorganic fluoride particles, that is, aluminum-containing lithium cobalt composite oxide particles as a raw material when being mixed and fired with the inorganic fluoride particles, are described also as the aluminum-containing lithium cobalt composite oxide particles (2).

The first mixing step is, for example, a step of mixing a lithium compound, a cobalt compound and an aluminum compound to obtain a first mixture containing the lithium compound, the cobalt compound and the aluminum compound.

The lithium compound relevant to the first mixing step is not especially limited as long as being a lithium compound usually used as a raw material for production of a lithium cobalt composite oxide, and includes an oxide, a hydroxide, a carbonate salt, a nitrate salt, a sulfate salt and organic acid salts of lithium.

The cobalt compound relevant to the first mixing step is not especially limited as long as being a cobalt compound usually used as a raw material for production of lithium cobalt composite oxides, and includes an oxide, an oxyhydroxide, a hydroxide, a carbonate salt, a nitrate salt, a sulfate salt and organic acid salts of cobalt.

The aluminum compound relevant to the first mixing step is not especially limited as long as being an aluminum compound to be used as a raw material for production of a lithium cobalt composite oxide containing aluminum element added therein, and includes an oxide, a hydroxide, a carbonate salt, a nitrate salt, a sulfate salt and an organic acid salt of aluminum. Among these, as the aluminum compound, aluminum hydroxide is preferable.

In the first mixing step, with regard to the mixing proportion of the cobalt compound to the lithium compound, the lithium compound and the cobalt compound are mixed so that the molar ratio (Li/Co) in terms of atoms of Li with respect to Co in the first mixture becomes preferably 0.90 to 1.20, especially preferably 0.95 to 1.15 and further especially preferably 1.03 to 1.06. Due to that the mixing proportion of the lithium compound and the cobalt compound is in the above range, it becomes easy for a single phase of a lithium cobalt composite oxide containing aluminum in X-ray diffractometry to be obtained.

In the first mixing step, with regard to the mixing proportion of the aluminum compound, the aluminum compound is mixed so that the % by mol ((Al/Co)×100) in terms of atoms of Al with respect to Co in the first mixture becomes preferably 0.05 to 5.0% by mol and especially preferably 0.5 to 2.0% by mol. Due to that the mixing proportion of the aluminum compound is in the above range, the cycle characteristics at high voltages and the cycle characteristics at high voltages and at high temperatures and the high-temperature storage characteristics can be improved without impairing the charge and discharge capacities of the lithium cobalt composite oxide in itself.

In the first mixing step, for the purpose of improving the performance or the physical properties, a compound containing an M element(s) can be mixed to the first mixture.

The M element is one or two or more metal elements selected from Ca, Mg, Sr, Zr, Nb, B and W. Compounds containing an M element include oxides, hydroxides, carbonate salts, nitrate salts and organic acid salts containing the M element. Compounds containing two or more M elements may be used.

In the first mixing step, in the case where a compound containing the M element, with regard to the mixing proportion of the compound containing the M element, the compound containing the M element is mixed so that the % by mol (((M/Co)×100) in terms of atoms of the M element with respect to Co atoms in the first mixture becomes preferably 0.01 to 2.0% by mol and especially preferably 0.05 to 1.0% by mol. Due to that the mixing proportion of the compound containing the M element is in the above range, the battery characteristics can be improved without impairing the charge and discharge capacities of the positive electrode active substance for a lithium secondary battery.

In the first mixing step, examples of a method of mixing the lithium compound, the cobalt compound, the aluminum compound and the compound containing an M element to be used as required include mixing methods using a coffee mill, a ribbon mixer, a Henschel mixer, a Supermixer, a Nauta mixer or the like.

The first firing step is a step of firing the first mixture obtained by carrying out the first mixing step to thereby obtain the aluminum-containing lithium cobalt composite oxide particles (2) containing aluminum solid-soluted and present in the particle interior.

In the first firing step, the firing temperature when the first mixture is fired to react the raw materials is 800 to 1,150 °C and preferably 850 to 1,100 °C. Due to that the firing temperature is in the above range, formation of unreacted cobalt oxide or superheated decomposition products of the lithium cobalt composite oxide causing the capacity reduction of the aluminum-containing lithium cobalt composite oxide can be made little.

In the first firing step, the firing time when the first mixture is fired to cause the raw material to react is 1 to 30 hours, and preferably 5 to 20 hours. Then, the firing atmosphere in the first firing step is preferably an oxidative atmosphere such as air or oxygen gas.

The second firing step is a step of mixing the aluminum-containing lithium cobalt composite oxide particles (2) being the first fired material with the inorganic fluoride particles to thereby obtain a second mixture containing the aluminum-containing lithium cobalt composite oxide particles (2) and the inorganic fluoride particles.

In the second mixing step, with regard to the mixing amount of the inorganic fluoride particles, the inorganic fluoride particles are mixed so that the % by mol ((F/Co)×100) in terms of atoms of F with respect to Co in the aluminum-containing lithium cobalt composite oxide particles (2) being the first fired material becomes preferably 0.05 to 5.0% by mol and especially preferably 0.1 to 2.0% by mol. Due to that the mixing amount of the inorganic fluoride particles is in the above range, under suppression of reduction of the charge and discharge capacities of the positive electrode active substance for a lithium secondary battery, such an effect is enhanced that the cycle characteristics at high voltages are improved, and the impedance of the positive electrode active substance for a lithium secondary battery can be lowered. For example, if unreacted lithium carbonate remains on the surface of the aluminum-containing lithium cobalt composite oxide particles (2) being the first fired material, carbon dioxide gas is generated by decomposition products during charge and discharge, easily causing malfunctioning and raising the impedance. In the method for producing the positive electrode active substance for a lithium secondary battery of the present invention, the mixing and firing of the inorganic fluoride particles conceivably causes reaction of carbonate radicals, and unreacted lithium carbonate can be removed. Hence, it is presumed that the impedance can be lowered.

The inorganic fluoride particles in the second mixing step are MgF₂ and AlF₃.

The mixing proportion of MgF₂ is, in the molar ratio (MgF₂/AlF₃) thereof with respect to AlF₃, 0.05 to 50, and preferably 0.1 to 10 and especially preferably 0.7 to 5. Due to that the mixing proportion (MgF₂/AlF₃ molar ratio) of MgF₂ with respect to AlF₃ is in the above range, the initial discharge capacity and the impedance are both simultaneously satisfied, which is preferable.

In the second mixing step, examples of methods of mixing the aluminum-containing lithium cobalt composite oxide particles and the inorganic fluoride particles include mixing methods using a coffee mill, a ribbon mixer, a Henschel mixer, a Supermixer, a Nauta mixer, a ball mill, a bead mill or the like.

The second firing step is a step of firing the second mixture obtained in the second mixing step to thereby obtain a positive electrode active substance for a lithium secondary battery as a second fired material.

In the second firing step, the firing temperature when the second mixture is fired to cause the raw material to react is 200 to 1,100 °C, and preferably 500 to 1,000 °C and especially preferably 500 to 700 °C. Due to that the firing temperature is in the above range, moisture can sufficiently be removed and it can be made difficult for characteristics deterioration such as the reduction of the charge and discharge capacities and the lowering of the cycle characteristics to be caused.

In the second firing step, the firing time when the second mixture is fired to cause the raw material to react is 1 to 10 hours, and preferably 2 to 7 hours. Then, the firing atmosphere in the second firing step is preferably an oxidative atmosphere such as air or oxygen gas.

In the first step or the second step, as required, the firing may be carried out multiple times, and as required, after the firing, the fired material may be crushed or classified.

A positive electrode active substance for a lithium secondary battery of a second embodiment of the present invention (hereinafter, described also as a positive electrode active substance for a lithium secondary battery (2) of the present invention) is a fired material of a mixture of aluminum-containing lithium cobalt composite oxide particles (3) and inorganic fluoride particles,
wherein the aluminum-containing lithium cobalt composite oxide particles (3) contain aluminum solid-soluted and present at least in the interior of the aluminum-containing lithium cobalt composite oxide particles (3); and the inorganic fluoride particles are MgF₂ and AlF₃.

Then, in the positive electrode active substance for a lithium secondary battery (2) of the present invention, aluminum-containing lithium cobalt composite oxide particles before being fired as a mixture with the inorganic fluoride particles, that is, aluminum-containing lithium cobalt composite oxide particles as a raw material to be fired in the presence of the inorganic fluoride particles, are described also as the aluminum-containing lithium cobalt composite oxide particles (3).

The aluminum-containing lithium cobalt composite oxide particles (3) relevant to the positive electrode active substance for a lithium secondary battery (2) of the present invention contain aluminum solid-soluted and present at least in the interior of the aluminum-containing lithium cobalt composite oxide particles (3). The aluminum-containing lithium cobalt composite oxide particles (3) are not especially limited as long as containing aluminum solid-soluted and present at least in the interior of the aluminum-containing lithium cobalt composite oxide particles, but preferable are the aluminum-containing lithium cobalt composite oxide particles (2) obtained by carrying out the first mixing step and the second mixing step relevant to the production method of the positive electrode active substance for a lithium secondary battery of the present invention.

The inorganic fluoride particles relevant to the positive electrode active substance for a lithium secondary battery (2) of the present invention are MgF₂ and AlF₃.

Then, the positive electrode active substance for a lithium secondary battery (2) of the present invention is a fired material of a mixture of the aluminum-containing lithium cobalt composite oxide particles (3) and the inorganic fluoride particles. That is, the positive electrode active substance for a lithium secondary battery (2) of the present invention is a fired material obtained by firing a mixture obtained by mixing the aluminum-containing lithium cobalt composite oxide particles (3) and the inorganic fluoride particles.

In the positive electrode active substance for a lithium secondary battery (2) of the present invention, the fired material of a mixture of the aluminum-containing lithium cobalt composite oxide particles (3) and the inorganic fluoride particles is a material obtained by firing a mixture of the aluminum-containing lithium cobalt composite oxide particles (3) and the inorganic fluoride particles at a firing temperature of 200 to 1,100 °C, preferably at 500 to 1,000 °C, especially preferably 500 to 70000, for 1 to 10 hours, preferably for 2 to 7 hours, in an oxidative atmosphere such as air or oxygen gas.

In the positive electrode active substance for a lithium secondary battery (2) of the present invention, by firing a mixture of the aluminum-containing lithium cobalt composite oxide particles (3) and the inorganic fluoride particles, MgF₂ and AIF, F in the inorganic fluoride particles in the mixture is present in a state of MgF₂ and a compound containing Al and F. That is, the positive electrode active substance for a lithium secondary battery (2) of the present invention can also be said to be a positive electrode active substance for a lithium secondary battery which is a mixture of the aluminum-containing lithium cobalt composite oxide particles (3) with the inorganic fluoride particles which are MgF₂ and a compound containing Al and F. Then, the present inventors presume that the compound containing Al and F is AlF₃ and/or LiAlF₄.

In the aluminum-containing lithium cobalt composite oxide particles (3) relevant to the positive electrode active substance for a lithium secondary battery (2) of the present invention, the molar ratio (Li/Co) in terms of atoms of Li with respect to Co is preferably 0.90 to 1.20 and especially preferably 0.95 to 1.15. Due to that the molar ratio (Li/Co) in terms of atoms of Li with respect to Co in the aluminum-containing lithium cobalt composite oxide particles (3) is in the above range, the capacity per volume of the positive electrode active substance for a lithium secondary battery can be improved.

In the aluminum-containing lithium cobalt composite oxide particles (3) relevant to the positive electrode active substance for a lithium secondary battery (2) of the present invention, the % by mol ((Al/Co)×100) in terms of atoms of Al with respect to Co is preferably 0.05 to 5.0% by mol and especially preferably 0.5 to 2.01 by mol. Due to that the % by mol ((Al/Co)×100) in terms of atoms of Al with respect to Co in the aluminum-containing lithium cobalt composite oxide particles (3) is in the above range, under suppression of reduction of the charge and discharge capacities of the positive electrode active substance for a lithium secondary battery, the cycle characteristics at high voltages and the cycle characteristics at high voltages and at high temperatures, and the high-temperature storage characteristics can be improved.

The aluminum-containing lithium cobalt composite oxide particles (3) relevant to the positive electrode active substance for a lithium secondary battery (2) of the present invention contain Al as an essential additional element, but for the purpose of improving the performance or the physical properties, as required, the aluminum-containing lithium cobalt composite oxide particles (3) can contain an M element(s). The M element is one or two or more metal elements selected from Ca, Mg, Sr, Zr, Nb, B and W.

In terms that the battery characteristics become much higher, it is preferable that the aluminum-containing lithium cobalt composite oxide particles (3) relevant to the positive electrode active substance for a lithium secondary battery (2) of the present invention contain, as the M element, at least one of Ca and Sr, and it is especially preferable to contain at least one of Ca and Sr, and one or more selected from Mg, Zr, Nb, B and W. Then, it is preferable that the aluminum-containing lithium cobalt composite oxide particles (3) relevant to the positive electrode active substance for a lithium secondary battery (2) of the present invention of the present invention contain, as the M element, at least one or two or more selected from Ca, Mg, Sr and Zr. Then, it is preferable that the aluminum-containing lithium cobalt composite oxide particles (3) relevant to the positive electrode active substance for a lithium secondary battery (2) of the present invention contain, as the M element, Mg, Sr and Zr.

In the case where the aluminum-containing lithium cobalt composite oxide particles (3) relevant to the positive electrode active substance for a lithium secondary battery (2) of the present invention contain the M element, in the aluminum-containing lithium cobalt composite oxide particles (3), the % by mol ((M/Co)×100) in terms of atoms of the M element to Co atoms is preferably 0.01 to 2.0% by mol and especially preferably 0.05 to 1.0% by mol. In the case where the aluminum-containing lithium cobalt composite oxide particles (3) contain the M element, due to that the % by mol ((M/Co)×100) in terms of atoms of the M element to Co atoms in the aluminum-containing lithium cobalt composite oxide particles (3) is in the above range, the battery characteristics can be improved without impairing the charge and discharge capacities of the positive electrode active substance for a lithium secondary battery. Here, in the case where the aluminum-containing lithium cobalt composite oxide particles (3) contain two or more M elements, the molar number of the M elements in terms of atoms, which becomes the basis of the calculation of the % by mol, refers to the total of molar numbers of the M elements.

The M element may be present in the interior of the aluminum-containing lithium cobalt composite oxide particles (3), or may be present on the surface of the aluminum-containing lithium cobalt composite oxide particles (3), or may be present both in the particle interior and on the particle surface of the aluminum-containing lithium cobalt composite oxide particles (3).

In the case where the M element is present on the particle surface of the aluminum-containing lithium cobalt composite oxide particles (3), the M element may be present in a form of an oxide, a composite oxide, a sulfate salt, a phosphate salt or the like.

The aluminum-containing lithium cobalt composite oxide particles (3) relevant to the positive electrode active substance for a lithium secondary battery (2) of the present invention are a particulate material of the aluminum-containing lithium cobalt composite oxide. The average particle diameter of the aluminum-containing lithium cobalt composite oxide particles (3) is, in terms of the particle diameter (D50) at a cumulative volume of 50% in a particle size distribution determined by a laser diffraction scattering method, preferably 0.5 to 30 m and especially preferably 3 to 25 μm. Then, the BET specific surface area of the aluminum-containing lithium cobalt composite oxide particle (3) is preferably 0.05 to 5.0 m²/g and especially preferably 0.15 to 1.0 m²/g. Due to that the average particle diameter and the BET specific surface area of the aluminum-containing lithium cobalt composite oxide particle (3) are in the above ranges, the preparation and the coatability of a positive electrode mixture become easy, and further, an electrode high in the packing property can be obtained.

In the positive electrode active substance for a lithium secondary battery (2) of the present invention, the mixing amount of the inorganic fluoride particles in the mixture of the aluminum-containing lithium cobalt composite oxide particles (3) and the inorganic fluoride particles is, in % by mol ((F/Co)×100) in terms of atoms of F with respect to Co in the aluminum-containing lithium cobalt composite oxide particles (3), preferably 0.05 to 5.0% by mol and especially preferably 0.1 to 2.0% by mol. Due to that the % by mol ((F/Co)×100) in terms of atoms of F with respect to Co in the aluminum-containing lithium cobalt composite oxide particles (3) is in the above range, under suppression of reduction of the charge and discharge capacities, such an effect is enhanced that the cycle characteristics at high voltages are improved, and the impedance of the positive electrode active substance for a lithium secondary battery can be lowered.

The mixing proportion of MgF₂ is, in a molar ratio (MgF₂/AlF₃) with respect to AlF₃, 0.05 to 50, and preferably 0.1 to 10 and especially preferably 0.7 to 5. Due to that the mixing proportion (molar ratio of MgF₂/AlF₃) of MgF₂ to AlF₃ is in the above range, the initial discharge capacity and the impedance both can simultaneously be satisfied.

The average particle diameter of the inorganic fluoride particles relevant to the positive electrode active substance for a lithium secondary battery (2) of the present invention is, in the particle diameter (D50) at a cumulative volume of 50% in a particle size distribution determined by a laser diffraction scattering method, preferably 0.01 to 30 μm and especially preferably 0.1 to 20 μm. Due to that the average particle diameter of the inorganic fluoride particles is in the above range, trouble becomes less likely to be caused in a kneading step in preparation of a positive electrode mixture and in a coating step of coating the obtained positive electrode mixture on a positive electrode current collector.

The average particle diameter of the positive electrode active substance for a lithium secondary battery (2) of the present invention is, in the particle diameter (D50) at a cumulative volume of 50% in a particle size distribution determined by a laser diffraction scattering method, preferably 0.5 to 30 μm and especially preferably 3 to 25 μm. Then, the BET specific surface area of the positive electrode active substance for a lithium secondary battery (2) of the present invention is preferably 0.05 to 5.0 m²/g and especially preferably 0.15 to 1.0 m²/g. Due to that the average particle diameter or the BET specific surface area of the positive electrode active substance for a lithium secondary battery (2) of the present invention is in the above range, trouble becomes less likely to be caused in a kneading step in preparation of a positive electrode mixture and in a coating step of coating the obtained positive electrode mixture on a positive electrode current collector.

The lattice constant of the c axis of the positive electrode active substance for a lithium secondary battery (2) of the present invention is preferably 14.055 to 14.070 Å and especially preferably 14.055 to 14.065 Å. Due to that the lattice constant of the c axis is in the above range, collapse of the crystal structure by the charge and discharge can be reduced and the cycle characteristics can be improved.

In the second firing step relevant to the production method of a positive electrode active substance for a lithium secondary battery of the present invention, though a mixture of the aluminum-containing lithium cobalt composite oxide particles being a first fired material with the inorganic fluoride particles is fired, the firing in the second firing step does not affect the size of the lattice constant of the c axis of the aluminum-containing lithium cobalt composite oxide particles. Hence, in the positive electrode active substance for a lithium secondary battery (2) of the present invention, the size of the lattice constant of the c axis is caused by the aluminum-containing lithium cobalt composite oxide particles in the mixture of the aluminum-containing lithium cobalt composite oxide particles and the inorganic fluoride particles.

The lithium secondary battery of the present invention uses, as a positive electrode active substance, the positive electrode active substance for a lithium secondary battery of the present invention.

The lithium secondary battery of the present invention is composed of a positive electrode, a negative electrode, a separator and a nonaqueous electrolyte containing a lithium salt.

The positive electrode relevant to the lithium secondary battery of the present invention is formed, for example, by applying and drying a positive electrode mixture on a positive electrode current collector. The positive electrode mixture is composed of the positive electrode active substance, a conductive agent, a binder and as required, a filler and the like to be added.

In the lithium secondary battery of the present invention, the positive electrode has the positive electrode active substance for a lithium secondary battery of the present invention uniformly applied thereon. Hence, the lithium secondary battery of the present invention is high in the battery performance, and in particular, excellent in the cycle characteristics at high voltages, the cycle characteristics at high voltages and at high temperatures, and further, low in the impedance.

The content of the positive electrode active substance contained in the positive electrode mixture relevant to the lithium secondary battery of the present invention is 70 to 100% by mass and preferably 90 to 98% by mass.

The positive electrode current collector relevant to the lithium secondary battery of the present invention is not especially limited as long as being an electron conductor causing no chemical change in a constituted battery, but examples thereof include stainless steels, nickel, aluminum, titanium, burned carbon, and aluminum and stainless steels whose surface has been surface treated with carbon, nickel, titanium or silver. These may be used by oxidizing the surface thereof, or may also be used by imparting roughness to the current collector surface by a surface treatment. Examples of the form of the current collector include foils, films, sheets, nets, punched materials, laths, porous materials, foams, and formed bodies of fibers or nonwoven fabrics. The thickness of the current collector is not especially limited, but is preferably made to be 1 to 500 μm.

The conductive agent relevant to the lithium secondary battery of the present invention is not especially limited as long as being an electron conducting material causing no chemical change in a constituted battery. Examples thereof include graphites such as natural graphite and artificial graphite, carbon blacks such as carbon black, acetylene black, Ketjen black, channel black, furnace black, lamp black and thermal black, conductive fibers such as carbon fibers and metal fibers, metal powders such as powders of carbon fluoride, aluminum, nickel or the like, conductive whiskers such as whiskers of zinc oxide, potassium titanate or the like, conductive metal oxides such as titanium oxide, and conductive materials such as polyphenylene derivatives; examples of the natural graphite include vein graphite, flake graphite and amorphous graphite. These can be used singly or in a combination of two or more. The blend ratio of the conductive agent is, in the positive electrode mixture, 1 to 50% by mass and preferably 2 to 30% by mass.

Examples of the binder relevant to the lithium secondary battery of the present invention include starch, polyvinylidene fluoride, polyvinyl alcohol, carboxymethylcellulose, hydroxypropylcellulose, regenerated cellulose, diacetylcellulose, polyvinylpyrrolidone, tetrafluoroethylene, polyethylene, polypropylene, ethylene-propylene diene terpolymer (EPDM), sulfonated EPDM, styrene butadiene rubber, fluororubber, tetrafluoroethylene-hexafluoroethylene copolymers, tetrafluoroethylene-hexafluoropropylene copolymers, tetrafluoroethylene-perfluoroalkyl vinyl ether copolymers, vinylidene fluoride-hexafluoropropylene copolymers, vinylidene fluoride-chlorotrifluoroethylene copolymers, ethylene-tetrafluoroethylene copolymers, polychlorotrifluoroethylene, vinylidene fluoride-pentafluoropropylene copolymers, propylene-tetrafluoroethylene copolymers, ethylene-chlorotrifluoroethylene copolymers, vinylidene fluoride-hexafluoropropylene-tetrafluoroethylene copolymers, vinylidene fluoride-perfluoromethyl vinyl ether-tetrafluoroethylene copolymers, ethylene-acrylic acid copolymers or (Na⁺) ion-crosslinked materials thereof, ethylene-methacrylic acid copolymers or (Na⁺) ion-crosslinked materials thereof, ethylene-methyl acrylate copolymers or (Na⁺) ion-crosslinked materials thereof, ethylene-methyl methacrylate copolymers or (Na⁺) ion-crosslinked materials thereof, polysaccharides of polyethylene oxide or the like, thermoplastic resins, and polymers having rubber elasticity; and these can be used singly or in a combination of two or more. Here, when a compound is used which contains a functional group reactive with lithium, like polysaccharides, it is preferable that a compound having, for example, an isocyanate group is added to deactivate the functional group. The blend ratio of the binder is, in the positive electrode mixture, 1 to 50% by mass and preferably 2 to 15% by mass.

The filler relevant to the lithium secondary battery of the present invention is a material to suppress the volume expansion and the like of the electrode in the positive electrode mixture, and is added as required. As the filler, any filler can be used as long as being a fibrous material causing no chemical change in a constituted battery, but fibers, for example, fibers of olefinic polymers such as polypropylene and polyethylene, glass, and carbon are used. The amount of the filler to be added is not especially limited, but is preferably 0 to 30% by mass in the positive electrode mixture.

The negative electrode relevant to the lithium secondary battery of the present invention is formed by applying and drying a negative electrode material on a negative electrode current collector. The negative electrode current collector relevant to the lithium secondary battery of the present invention is not especially limited as long as being an electron conductor causing no chemical change in a constituted battery, but examples thereof include stainless steels, nickel, copper, titanium, aluminum, burned carbon, and copper and stainless steels whose surface has been surface treated with carbon, nickel, titanium or silver, and aluminum-cadmium alloys. These may be used by oxidizing the surface thereof, or may also be used by imparting roughness to the current collector surface by a surface treatment. Examples of the form of the current collector include foils, films, sheets, nets, punched materials, laths, porous materials, foams, and formed bodies of fibers or nonwoven fabrics. The thickness of the current collector is not especially limited, but is preferably made to be 1 to 500 μm.

The negative electrode material relevant to the lithium secondary battery of the present invention is not especially limited, but examples thereof include carbonaceous materials, metal composite oxides, lithium metal, lithium alloys, silicon-based alloys, tin-based alloys, metal oxides, conductive polymers, chalcogen compounds, Li—Co—Ni-based alloys, Li₄Ti₅O₁₂, lithium niobate, and silicon oxide (SiOₓ: 0.5≤x≤1.6) Examples of the carbonaceous materials include non-graphitizable carbon materials and graphite-based carbon materials. Examples of the metal composite oxides include compounds such as Snₚ(M1)₁₋ₚ(M2)_{q}Oᵣ (wherein M1 is one or more elements selected from Mn, Fe, Pb and Ge; M2 is one or more elements selected from Al, B, P, Si, periodic table group 1, group 2 and group 3 elements and halogen elements; and 0<p≤1, 1≤5 q≤3 and 1≤r≤8), LiₜFe₂O₃ (0≤t≤1) and LiₜWO₂ (0≤t≤1). The metal oxides include GeO, GeO₂, SnO, SnO₂, PbO, PbO₂, Pb₂O₃, Pb₃O₄, Sb₂O₃, Sb₂O₄, Sb₂O₅, Bi₂O₃, Bi₂O₄ and Bi₂O₅. The conductive polymers include polvacetylene and poly-p-phenylene.

As the separator relevant to the lithium secondary battery of the present invention, there is used an insulating thin film having a high ion permeability and having a predetermined mechanical strength. There is used a sheet or a nonwoven fabric composed of an olefinic polymer such as polypropylene, or glass fibers, or polyethylene, or the like from the viewpoint of the organic solvent resistance and the hydrophobicity. The pore diameter of the separator suffices if being in the range useful as pores for batteries, and is, for example, 0.01 to 10 μm. The thickness of the separator suffices if being in the range for usual batteries, and is, for example, 5 to 300 μm. Then, in the case where a solid electrolyte such as a polymer is used as an electrolyte described later, the solid electrolyte may serve also as a separator.

The nonaqueous electrolyte containing a lithium salt relevant to the lithium secondary battery of the present invention is composed of a nonaqueous electrolyte and the lithium salt. As the nonaqueous electrolyte relevant to the present invention, a nonaqueous electrolyte solution, an organic solid electrolyte or an inorganic solid electrolyte is used. Examples of the nonaqueous electrolyte solution include one of or mixed solvents of two or more of aprotic organic solvents such as N-methyl-2-pyrroridinone, propylene carbonate, ethylene carbonate, butylene carbonate, dimethyl carbonate, diethyl carbonate, γ-butyrolactone, 1,2-dimethoxyethane, tetrahydroxyfuran, 2-methyltetrahydrofuran, dimethyl sulfoxide, 1,3-dioxolane, formamide, dimethylformamide, dioxolane, acetonitrile, nitromethane, methyl formate, methyl acetate, phosphate triesters, trimetoxymethane, dioxolane derivatives, sulfolane, methyl sulfolane, 3-methyl-2-oxazolidinone, 1,3-dimethyl-2-imidazolidinone, propylene carbonate derivatives, tetrahydrofuran derivatives, diethyl ether, 1,3-propanesultone, methyl propionate and ethyl propionate.

Examples of the organic solid electrolyte relevant to the lithium secondary battery of the present invention include: polymers containing ionic dissociation groups of polyethylene derivatives, polyethylene oxide derivatives or polymers containing these, polypropylene oxide derivatives or polymers containing these, phosphate ester polymers, polyphosphazene, polyaziridine, polyethylene sulfide, polyvinyl alcohol, polyvinylidene fluoride, polyhexafluoropropylene, and the like; and mixtures of the polymer containing ionic dissociation groups and the above-mentioned nonaqueous electrolyte solution.

As the inorganic solid electrolyte relevant to the lithium secondary battery of the present invention, there can be used a nitride, a halide, an oxygen acid salt, a sulfide or the like of Li; and examples thereof include Li₃N, LiA, LisNI₂, Li₃N—LiI—LiOH, LiSiO₄, LiSiO₄—LiI—LiOH, Li₂SiS₃, Li₄SO₄, Li₄SiO₄—LiI—LiOH, P₂S, Li₂S or Li₂S—P₂S₅, Li₂S—SiS₂, Li₂S—GeS₂, Li₂S—Ga₂S₃, Li₂S—B₂S₃, Li₂S—P₂S₅—X, Li₂S—SiS₂—X, Li₂S—GeS₂—X, Li₂S—Ga₂S—X, Li₂S—B₂S₃—X, (wherein X is at least one or more selected from LiI, B₂S₃ and Al₂S₃).

Further when the inorganic solid electrolyte is an amorphous material (glass), the inorganic solid electrolyte can be made to contain a compound containing oxygen, such as Lithium phosphate (LiPO₄), lithium oxide (Li₂O), lithium sulfate (Li₂SO₄), phosphorus oxide (P₂O₅) or lithium borate (Li₃BO₃), or a compound containing nitrogen, such as Li₃PO₄−uN₂u/₃ (u is 0<u<4), Li₄SiO₄−uN2u/3 (u is 0<u<4), Li₄GeO₄−uN₂u/₃ (u is 0<u<4) or Li₃BO₃−uN₂u/₃ (u is 0<u<3). The addition of the compound containing oxygen or the compound containing nitrogen leads to expansion of interstices in an amorphous skeleton formed, whereby the hindrance to lithium ion migration can be reduced, and further the ionic conductivity can be improved.

As the lithium salt relevant to the lithium secondary battery of the present invention, those dissolving in the above nonaqueous electrolyte are used, and examples thereof include one of or mixed salts of two or more of LiCi, LiBr, LiI, LiClO₄, LiBF₄, LiBioClio, LiPF₆, LiCF₃SO₃, LiCF₃CO₂, LiAsF₆, LiSbF₆, LiBioClio, LiAlCl₄, CH₃SO₃Li, CF₃SO₃Li, (CF₃SO₂)₂NLi, chloroborane lithium, lithium lower aliphatic carboxylates, lithium tetraphenylborate, and imides.

Then, to the nonaqueous electrolyte, compounds indicated below can be added for the purpose of improving charge and discharge characteristics and the flame retardancy. Examples thereof include pyridine, triethyl phosphite, triethanolamine, cyclic ethers, ethylenediamine, n-glyme, triamide hexaphosphate, nitrobenzene derivatives, sulfur, quinoneimine dyes, N-substituted oxazolidinone, N,N-substituted imidazolidine, ethylene glycol dialkyl ethers, ammonium salts, polyethylene glycol, pyrrole, 2-methoxyethanol, aluminum trichloride, monomers of conductive polymeric electrode active substances, triethylene phosphonamide, trialkyl phosphines, morpholine, aryl compounds having a carbonyl group, hexamethylphosphoric triamide, 4-alkylmorpholines, dicyclic tertiary amines, oils, phosphonium salts, tertiary sulfonium salts, phosphazene and carbonate esters. Further in order to make the electrolyte solution to be nonflammable, the electrolyte solution can be made to contain a halogen-containing solvent, for example, carbon tetrachloride or ethylene trifluoride. Further in order to make the electrolyte solution to have suitability for high-temperature storage, the electrolyte solution can be made to contain carbon dioxide gas.

The lithium secondary battery of the present invention is one high in the capacity per volume, excellent in safety and the cycle characteristics, high in the energy density retention rate, and little in the lowering of the average operation voltage; and the battery shape may be any shape of button, sheet, cylinder, rectangle, coin and the like.

Applications of the lithium secondary battery of the present invention are not especially limited, but examples thereof include electronic devices such as notebook personal computers, laptop personal computers, pocket word processors, mobile phones, cordless slave units, portable CD players, radios, liquid crystal televisions, backup power sources, electric shavers, memory cards, video movies, automobiles, motorized vehicles, game machines, robots, drones, electric power tools and the like.

### EXAMPLES

Hereinafter, the present invention will be described in more detail by way of Examples, but the present invention is not any more limited thereto.

(X-Ray Diffractometry) In Examples, the measurement was carried out by using an X-ray diffraction analyzer (Ultima IV, manufactured by Rigaku Corp.) under the following measurement condition.
Line source: CuKα
Tube voltage: 40 kV
Tube current: 40 mA
Scanning speed: 4.0°/sec

### Example 1

### (First Mixing Step)

Tricobalt tetraoxide (average particle diameter: 2.1 μm), lithium carbonate (average particle diameter: 5.7 μm) and aluminum hydroxide (average particle diameter: 1.6 μm) were weighed and mixed by a coffee mill to obtain a first mixture in which the molar ratio (Li/Co) of Li to Co was 1.040, and the % by mol ((Al/Co)×100) of Al to Co was 1.0% by mol.

### (First Firing Step)

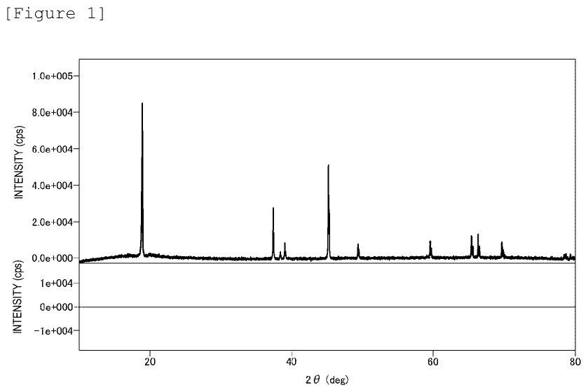

Then, the obtained first mixture was fired at 900 °C for 5 hours in an alumina bowl. The fired product was X-ray diffractometrically analyzed; and since the fired product was a single-phase LiCoO₂, it was verified that Al was solid-soluted and contained in the interior of the lithium cobalt composite oxide particle (see FIG. 1).

After the completion of the firing, the fired product was crushed and classified to obtain aluminum-containing lithium cobalt composite oxide particles containing Al of 1.0% by mol to Co.

### (Second Mixing Step)

Then, the obtained aluminum-containing lithium cobalt composite oxide particles, and MgF₂ (average particle diameter D50: 0.9 μm) and AlF₃ (average particle diameter D50: 2.2 μm) were weighed and mixed by a coffee mill to obtain a second mixture in which the % by mol ((F/Co)×100) of F to Co was 0.9% by mol, and the content proportion of MgF₂ was 3 in the molar ratio (MgF₂/AlF₃) to AlF₃.

### (Second Firing Step)

Then, the obtained second mixture was fired at 600 °C for 5 hours in an alumina bowl.

After the completion of the firing, the fired product was crushed and classified to thereby obtain a positive electrode active substance sample.

### Examples 2 to 7

By the same operation as in Example 1, fired products were each obtained through a first mixing step and a first firing step indicated in Table 1. The fired products were X-ray diffractometrically analyzed; and since the fired products were each a single-phase LiCoO₂, it was verified that Al was solid-soluted and contained in the interior of the lithium cobalt composite oxide particles.

Then, the fired products were each crushed and classified to obtain an aluminum-containing lithium cobalt composite oxide. Then, positive electrode active substance samples were each obtained as in Example 1 through a second mixing step and a second firing step.

### Comparative Example 1

### (First Mixing Step)

Tricobalt tetraoxide (average particle diameter: 2.1 μm) and lithium carbonate (average particle diameter: 5.7 μm) were weighed and mixed by a coffee mill to obtain a first mixture in which the molar ratio (Li/Co) of Li to Co was 1.040.

### (First Firing Step)

Then, the obtained first mixture was fired at 900 °C for 5 hours in an alumina bowl. The fired product was X-ray diffractometrically analyzed, and the fired product was a single-phase LiCoO₂.

After the completion of the firing, the fired product was crushed and classified to obtain aluminum-containing lithium cobalt composite oxide particles.

### (Second Mixing Step)

Then, the obtained aluminum-containing lithium cobalt composite oxide particles, and MgF₂ (average particle diameter: 0.9 μm) and AlF₃ (average particle diameter: 2.2 μm) were weighed and mixed by a coffee mill to obtain a second mixture in which the % by mol ((F/Co)×100) of F to Co was 0.91 by mol, and the content proportion of MgF₂ was 3 in the molar ratio (MgF₂/AlF₃) to AlW.

### (Second Firing Step)

Then, the obtained second mixture was fired at 600 °C for 5 hours in an alumina bowl.

After the completion of the firing, the fired product was crushed and classified to thereby obtain a positive electrode active substance sample.

### Comparative Example 2

### (First Mixing Step)

Tricobalt tetraoxide (average particle diameter: 2.1 μm), lithium carbonate (average particle diameter: 5.7 μm) and aluminum hydroxide (average particle diameter: 1.6 μm) were weighed and mixed by a coffee mill to obtain a first mixture in which the molar ratio (Li/Co) of Li to Co was 1.040, and the % by mol ((Al/Co)×100) of Al to Co was 1.0% by mol.

### (First Firing Step)

Then, the obtained first mixture was fired at 900 °C for 5 hours in an alumina bowl. The fired product was X-ray diffractometrically analyzed, and the fired product was a single-phase LiCoO₂.

After the completion of the firing, the fired product was crushed and classified to obtain a positive electrode active substance sample.

### Reference Example 1

### (First Mixing Step)

Tricobalt tetraoxide (average particle diameter: 2.1 μm), lithium carbonate (average particle diameter: 5.7 μm), titanium dioxide (average particle diameter: 0.4 μm) and calcium sulfate (average particle diameter: 7.3 μm) were weighed and mixed by a household mixer to obtain a first mixture in which the molar ratio (Li/Co) of Li to Co was 1.043; the % by mol ((Ti/Co)×100) of Ti to Co was 1.0% by mol; and the % by mol ((Ca/Co)×100) of Ca to Co was 0.06% by mol.

### (First Firing Step)

Then, the obtained first mixture was fired at 1,070 °C for 5 hours in an alumina bowl.

After the completion of the firing, the fired product was crushed and classified to obtain lithium cobalt composite oxide particles containing Ti of 1.01 by mol to Co, and Ca of 0.06% by mol to Co.

### (Second Mixing Step)

Then, the obtained lithium cobalt composite oxide particles, and MgF₂ (average particle diameter: 0.9 μm) and AlF₃ (average particle diameter: 2.2 μm) were weighed and mixed by a coffee mill to obtain a second mixture in which the % by mol ((F/Co)×100) of F to Co was 0.85% by mol, and the content proportion of MgF₂ was 0.625 in the molar ratio (MgF₂/AlF₃) to AlF₃.

### (Second Firing Step)

Then, the obtained second mixture was fired at 600 °C for 5 hours in an alumina bowl.

After the completion of the firing, the fired product was crushed and classified to thereby obtain a positive electrode active substance sample.

For the positive electrode active substances obtained in Examples 1 to 7, Comparative Examples 1 and 2 and Reference Example 1, the following physical properties (the average particle diameter, the BET specific surface area, and the lattice constant of the c axis) were measured. The results are shown in Table 1 and Table 2.

### (1) the Average Particle Diameter

The average particle diameter was determined from the particle diameter (D50) at a cumulative volume of 50% in a particle size distribution measured by a laser diffraction scattering method.

### (2) the BET Specific Surface Area

The BET specific surface area was measured by a BET method.

### (3) the Lattice Constant of the c Axis

The lattice constant of the c axis was measured by Rietvelt analysis using a diffraction pattern measured by X-ray diffractometry (XRD).

TABLE 1

| | Example | Example | Example | Example | Example |
|---|---|---|---|---|---|
| | 1 | 2 | 3 | 4 | 5 |
| Production condition of | | | | | |
| positive electrode active | | | | | |
| substance | | | | | |
| First mixing step | | | | | |
| Molar ratio of Li to Co | 1.040 | 1.040 | 1.040 | 1.040 | 1.040 |
| % by mol of Al to Co | 1.00 | 0.50 | 2.00 | 0.75 | 1.00 |
| First firing step | | | | | |
| Firing temperature (°C) | 900 | 900 | 900 | 900 | 950 |
| Firing time (hours) | 5 | 5 | 5 | 5 | 5 |
| Second mixing step | | | | | |
| % by mol of F to Co | 0.90 | 0.90 | 0.90 | 0.90 | 0.90 |
| MgF₂/AlF₃ molar ratio | 3 | 3 | 3 | 3 | 3 |
| Second firing step | | | | | |
| Firing temperature (°C) | 600 | 600 | 600 | 600 | 600 |
| Firing time (hours) | 5 | 5 | 5 | 5 | 5 |
| Physical properties of | | | | | |
| positive electrode active | | | | | |
| substance | | | | | |
| Average particle diameter | 6.1 | 7.0 | 5.1 | 6.5 | 7.1 |
| (μm) | | | | | |
| BET specific surface area | 0.6 | 0.4 | 0.5 | 0.44 | 0.44 |
| (m²/g) | | | | | |
| Lattice constant of c axis | 14.059 | 14.055 | 14.06 | 14.056 | — |
| (Å) | | | | | |

TABLE 2

| | | | Comparative | Comparative | |
|---|---|---|---|---|---|
| | Example | Example | Example | Example | Reference |
| | 6 | 7 | 1 | 2 | Example 1 |
| Production condition of | | | | | |
| positive electrode active | | | | | |
| substance | | | | | |
| First mixing step | | | | | |
| Molar ratio of Li to Co | 1.040 | 1.050 | 1.040 | 1.040 | 1.043 |
| % by mol of Al to Co | 1.00 | 1.00 | — | 1.00 | * |
| First firing step | | | | | |
| Firing temperature (°C) | 1000 | 900 | 900 | 900 | 1070 |
| Firing time (hours) | 5 | 5 | 5 | 5 | 5 |
| Second mixing step | | | | | |
| % by mol of F to Co | 0.90 | 0.90 | 0.90 | — | 0.85 |
| MgF₂/AlF₃ molar ratio | 3 | 3 | 3 | — | 0.625 |
| Second firing step | | | | | |
| Firing temperature (°C) | 600 | 600 | 600 | — | 600 |
| Firing time (hours) | 5 | 5 | 5 | — | 5 |
| Physical properties of | | | | | |
| positive electrode active | | | | | |
| substance | | | | | |
| Average particle diameter | 8.8 | 7.7 | 7.3 | 6.6 | 8.6 |
| (μm) | | | | | |
| BET specific surface area | 0.39 | 0.38 | 0.39 | 0.54 | 0.37 |
| (m²/g) | | | | | |
| Lattice constant of c axis | — | — | 14.053 | 14.058 | 14.068 |
| (Å) | | | | | |

In table 2, * indicates that the % by mol of Ti to Co was 1.0% by mol, and the % by mol of Ca to Co was 0.06% by mol.

Comparing, in Table 1 and Table 2, the positive electrode active substance sample containing no Al solid-soluted (Comparative Example 1) with the positive electrode active substance samples containing Al solid-soluted Examples 1 to 4), it is seen that the positive electrode active substance samples containing Al solid-soluted had a larger lattice constant of the c axis.

It is further seen that in Example 2, the Al content was 0.5% by mol (lattice constant of the c axis: 14.055 Å); in Example 4, 0.75% by mol (lattice constant of the c axis: 14.056 Å); in Example 1, 1.0% by mol (lattice constant of the c axis: 14.059 Å); and in Example 3, 2.0% by mol (lattice constant of the c axis: 14.060 Å), so, the higher the Al content was, the larger the lattice constant of the c axis was.

Then, battery performance tests were carried out as follows.

### <Fabrication of Lithium Secondary Batteries>

95% by mass of the positive electrode active substance obtained in Examples 1 to 7, Comparative Examples 1 and 2 and Reference Example 1 each, 2.5% by mass of a graphite powder and 2.5% by mass of a polyvinylidene fluoride were mixed to make a positive electrode mixture, and the mixture was dispersed in N-methyl-2-pyrrolidinone to thereby prepare a kneaded paste. The kneaded paste was applied on an aluminum foil, thereafter dried and pressed and punched out into a disc of 15 mm in diameter to thereby obtain a positive electrode plate.

By using the positive electrode plate, each member of a separator, a negative electrode, a positive electrode, current collectors, mounting metal fittings, external terminals, an electrolyte solution and the like was used to thereby fabricate a coin-type lithium secondary battery. Among these, the negative electrode used was a metal lithium foil, and the electrolyte solution used was one in which 1 mol of LiPF₆ and 1% by weight of vinylene carbonate were dissolved in 1 L of a mixed solution of ethylene carbonate, dimethyl carbonate and diethyl carbonate in 2.5:6:1.5.

### <Performance Evaluations of the Batteries>

For the fabricated coin-type lithium secondary batteries each, the following battery performance (cycle characteristics at high voltages, cycle characteristics at high voltages and at high temperatures, and impedance) was evaluated. The results are shown in Table 3, Table 4 and Table 5.

### (1) Evaluation of Cycle Characteristics at High Voltages

### (1-1) Test Condition

First, on the battery, there was carried out constant current-constant voltage charge (CCCV charge) in which charge at 0.5C up to 4.6 V was carried out over 2 hours and the voltage of 4.6 V was held for 3 hours. Thereafter, constant current discharge (CC discharge) at 0.2C down to 2.7 V was carried out. The operation of these charge and discharge was taken as one cycle, and the discharge capacity was measured at every one cycle. This cycle was repeated 20 times at 25 °C.

### (1-2) the Initial Discharge Capacity at High Voltages

The first-cycle discharge capacity in the evaluation of the cycle characteristics was taken as an initial discharge capacity (25 °C initial discharge capacity (4.6 V)).

### (1-3) the Capacity Retention Rate at High Voltages

The capacity retention rate at high voltages (25 °C capacity retention rate (4.6 V)) was calculated by the following expression from the respective discharge capacities (per active substance weight) of the first cycle and the 20th cycle in the evaluation of the cycle characteristics.

Capacity retention rate (%)=(a discharge capacity of the 20th cycle/a discharge capacity of the first cycle)×100

### (2) Evaluation of Cycle Characteristics at High Voltages and at High Temperatures

### (2-1) Test Condition

First, on the battery, there was carried out constant current-constant voltage charge (CCCV charge) in which charge at 0.5C up to 4.55 V was carried out over 2 hours and the voltage of 4.55 V was held for 3 hours. Thereafter, constant current discharge (CC discharge) at 0.2C down to 2.7 V was carried out. The operation of these charge and discharge was taken as one cycle, and the discharge capacity was measured at every one cycle. This cycle was repeated 50 times at 45 °C.

### (2-2) The Initial Discharge Capacity at High Voltages and at High Temperatures

The first-cycle discharge capacity in the evaluation of the high-temperature cycle characteristics was taken as an initial discharge capacity at high voltages and at high temperatures (45 °C initial discharge capacity (4.55 V)).

### (2-3) The Capacity Retention Rate at High Voltages and at High Temperatures

The capacity retention rate at high voltages and at high temperatures (45 °C capacity retention rate (4.55 V)) was calculated by the following expression from the respective discharge capacities (per active substance weight) of the first cycle and the 50th cycle in the evaluation of the high-temperature cycle characteristics.

Capacity retention rate at high voltages and at high temperatures (%)=(a discharge capacity of the 50th cycle/a discharge capacity of the first cycle)×100

### (3) The Impedance

The coin-type lithium secondary battery was charged in an SOC of 100%, that is, in a full state of charge, and thereafter, an alternating-current impedance measurement was carried out by using an impedance measuring device under a voltage applied to the open circuit of 0 V, that is, under no voltage applied, in a frequency range of 0.02 Hz to 20 kHz. Then, the resistance value was determined from a Cole-Cole plot obtained by the alternating-current impedance measurement.

TABLE 3

| | | 25 °C Capacity retention |
|---|---|---|
| | 25 °C Initial discharge | rate (4.6 V) |
| | capacity (4.6 V) | (20th cycle) |
| | (mAh/g) | (%) |
| Example 1 | 214 | 72.6 |
| Example 2 | 217 | 64.5 |
| Example 3 | 210 | 84.2 |
| Example 4 | 215 | 67.1 |
| Example 5 | 215 | 69.9 |
| Example 6 | 213 | 65.6 |
| Example 7 | 205 | 69.4 |
| Comparative | 220 | 64.3 |
| Example 1 | | |
| Comparative | 210 | 70.8 |
| Example 2 | | |
| Reference | 208 | 43.4 |
| Example 1 | | |

TABLE 4

| | | 45 °C Capacity retention |
|---|---|---|
| | 45 °C Initial discharge | rate (4.55 V) |
| | capacity (4.55 V) | (50th cycle) |
| | (mAh/g) | (%) |
| Example 1 | 202 | 70.1 |
| Example 2 | — | — |
| Example 3 | 204 | 76.4 |
| Example 4 | 198 | 64.3 |
| Example 5 | 202 | 70.9 |
| Example 6 | 203 | 66.4 |
| Example 7 | — | — |
| Comparative | 199 | 55.7 |
| Example 1 | | |
| Comparative | 201 | 69.8 |
| Example 2 | | |
| Reference | 198 | 34.3 |
| Example 1 | | |

TABLE 5

| | Impedance |
|---|---|
| | (Ω) |
| Example 1 | 6 |
| Example 2 | 4 |
| Example 3 | 7 |
| Example 4 | 4 |
| Example 5 | 9 |
| Example 6 | 5 |
| Example 7 | 4 |
| Comparative | 5 |
| Example 1 | |
| Comparative | 37 |
| Example 2 | |
| Reference | 4 |
| Example 1 | |

1. A positive electrode active substance for a lithium secondary battery, the positive electrode active substance comprising a mixture of aluminum-containing lithium cobalt composite oxide particles and inorganic fluoride particles,
wherein the aluminum-containing lithium cobalt composite oxide particles contain aluminum solid-soluted and present at least in the interior of the aluminum-containing lithium cobalt composite oxide particles; and the inorganic fluoride particles are MgF₂ and a compound containing Al and F.

2. The positive electrode active substance for a lithium secondary battery according to claim 1, wherein the compound containing Al and F is AlF₃ and/or LiAlF₄.

3. The positive electrode active substance for a lithium secondary battery according to claim 1, wherein a content of Al in the aluminum-containing lithium cobalt composite oxide particles is, in % by mol ((Al/Co)×100) in terms of atoms of Al with respect to Co in the aluminum-containing lithium cobalt composite oxide particles, 0.05 to 5.0% by mol.

4. The positive electrode active substance for a lithium secondary battery according to claim 1, wherein a content of F in the aluminum-containing lithium cobalt composite oxide particles is, in % by mol ((F/Co)×100) in terms of atoms of F with respect to Co in the aluminum-containing lithium cobalt composite oxide particles, 0.05 to 5.0% by mol.

5. The positive electrode active substance for a lithium secondary battery according to claim 1, wherein a mixing proportion of the MgF₂ and the compound containing Al and F is, in a molar ratio (a molar number in terms of atoms of F of MgF₂/a molar number in terms of atoms of F of the compound containing Al and F) of a molar number in terms of atoms of F of MgF₂ with respect to a molar number in terms of atoms of F of the compound containing Al and F, 0.033 to 33.

6. The positive electrode active substance for a lithium secondary battery according to claim 1, wherein the positive electrode active substance has a lattice constant of the c axis of 14.055 to 14.070 Å.

7. The positive electrode active substance for a lithium secondary battery according to claim 1, wherein the aluminum-containing lithium cobalt composite oxide particles contain one or two or more M elements selected from the group consisting of Ca, Mg, Sr, Zr, Nb, B and W.

8. A positive electrode active substance for a lithium secondary battery, the positive electrode active substance being a fired material of a mixture of aluminum-containing lithium cobalt composite oxide particles and inorganic fluoride particles,
wherein the aluminum-containing lithium cobalt composite oxide particles contain aluminum solid-soluted and present at least in the interior of the aluminum-containing lithium cobalt composite oxide particles; and the inorganic fluoride particles are MgF₂ and AlF₃.

9. The positive electrode active substance for a lithium secondary battery according to claim 8, wherein the aluminum-containing lithium cobalt composite oxide particles are a fired material of a mixture of a lithium compound, a cobalt compound and an aluminum compound.

10. The positive electrode active substance for a lithium secondary battery according to claim 8, wherein a content of Al in the aluminum-containing lithium cobalt composite oxide particles is, in % by mol ((Al/Co)×100) in terms of atoms of Al with respect to Co in the aluminum-containing lithium cobalt composite oxide particles, 0.05 to 5.0% by mol.

11. The positive electrode active substance for a lithium secondary battery according to claim 8, wherein an amount of the inorganic fluoride particles mixed in the mixture of aluminum-containing lithium cobalt composite oxide particles and inorganic fluoride particles is, in % by mol (F/Co×100) in terms of atoms of F with respect to Co in the aluminum-containing lithium cobalt composite oxide particles, 0.05 to 5.0% by mol.

12. The positive electrode active substance for a lithium secondary battery according to claim 8, wherein a mixing proportion of the MgF₂ in the mixture of aluminum-containing lithium cobalt composite oxide particles and inorganic fluoride particles is, in a molar ratio (MgF₂/AlF₃) with respect to the AlF₃, 0.05 to 50.

13. The positive electrode active substance for a lithium secondary battery according to claim 8, wherein the positive electrode active substance has a lattice constant of the c axis of 14.055 to 14.070 Å.

14. The positive electrode active substance for a lithium secondary battery according to claim 8, wherein the aluminum-containing lithium cobalt composite oxide particles contain one or two or more M elements selected from the group consisting of Ca, Mg, Sr, Zr, Nb, B and W.

15. A method for producing a positive electrode active substance for a lithium secondary battery, the method comprising:
a first mixing step of mixing a lithium compound, a cobalt compound and an aluminum compound as raw materials to obtain a first mixture;
a first firing step of firing the first mixture to obtain, as a first fired material, aluminum-containing lithium cobalt composite oxide particles containing aluminum solid-soluted and present at least in the interior of the particles;
a second mixing step of mixing the first fired material obtained in the first firing step with inorganic fluoride particles to obtain a second mixture; and
a second firing step of firing the second mixture to obtain, as a second fired material, a positive electrode active substance for a lithium secondary battery,
wherein the inorganic fluoride particles are MgF₂ and AlF₃.

16. The method for producing a positive electrode active substance for a lithium secondary battery according to claim 15, wherein in the first mixing step, the aluminum compound is mixed so that a % by mol ((Al/Co)×100) in terms of atoms of Al with respect to Co in the first mixture becomes 0.05 to 5.0% by mol.

17. The method for producing a positive electrode active substance for a lithium secondary battery according to claim 15, wherein the first fired material contains one or two or more M elements selected from the group consisting of Ca, Mg, Sr, Zr, Nb, B and W.

18. The method for producing a positive electrode active substance for a lithium secondary battery according to claim 15, wherein in the first firing step, a firing temperature is 800 to 1,150 °C.

19. The method for producing a positive electrode active substance for a lithium secondary battery according to claim 15, wherein in the second mixing step, the inorganic fluoride particles are mixed so that a % by mol ((F/Co)×100) in terms of atoms of F with respect to Co in the second mixture becomes 0.05 to 2.0% by mol.

20. The method for producing a positive electrode active substance for a lithium secondary battery according to claim 15, wherein the positive electrode active substance for a lithium secondary battery being the second fired material has a lattice constant of the c axis of 14.055 to 14.070 Å.

21. A lithium secondary battery, comprising, as a positive electrode active substance, a positive electrode active substance for a lithium secondary battery according to claim 1.
